(19) United States
(12) Patent Application Publication
(10) Pub. No.: US 2015/0327011 A1
(43) Pub. Date: Nov. 12, 2015

(54) EMPLOYEE TIME AND PROXIMITY TRACKING

(71) Applicant: Vivint, Inc., Provo, UT (US)

(72) Inventor: Greg Fairbanks, Cedar Hills, UT (US)

(73) Assignee: Vivint, Inc., Provo, UT (US)

(21) Appl. No.: 14/272,267

(22) Filed: May 7, 2014

(51) Int. Cl. H04W 4/02; H04W 64/00; H04M 1/02

(52) U.S. Cl. CPC H04W 4/021; H04M 1/0202; H04W 64/00

(57) ABSTRACT

Systems and methods for tracking employee time and proximity are described. According to at least one embodiment, a computer-implemented method to track employees in disclosed. The method may comprise registering a mobile device associated with an employee and recognizing when the mobile device associated with the employee enters a location. The method may include monitoring the mobile device once it enters the location and generating a report based at least in part on the monitoring.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to the computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of technology in everyday life. Advancements in mobile devices and related mobile technology allow users to monitor their location, movement, and/or other aspects of everyday life. As technology expands into homes and businesses, opportunities exist for using technology for alternative purposes such as tasks related to a business and employee tracking.

### SUMMARY

According to at least one embodiment, a computer-implemented method to track employees in disclosed. The method may comprise registering a mobile device associated with an employee and recognizing when the mobile device associated with the employee enters a location. The method may include monitoring the mobile device once it enters the location and generating a report based at least in part on the monitoring.

In some embodiments, the method may include establishing a location, wherein establishing the location may include setting up a wireless network. The location may be a commercial location. The location may be defined by a virtual perimeter created by a wireless network. The virtual perimeter may incorporate a business location. The method may also include establishing one or more sectors within the location, wherein the one or more sectors define one or more different zones of the location. In some embodiments, the method may register multiple mobile devices. Each mobile device may be associated with a different employee. The method may differentiate between the mobile devices when the mobile devices enter the location.

In some embodiments, monitoring the mobile device may include recording a time when the mobile enters the location, recording a time when the mobile device leaves the location. The method may calculate a total time the mobile device was within the location. In some embodiments, the method may monitor movement of the mobile device within the location. According to another embodiment, the report may contain time-stamps relating to when the employee entered and exited the location. The report may compare the time-stamps to a time entry log from a time entry database.

In alternative embodiments, the method may generate a message to remind the employee to clock-in to work. The method may send the message to the mobile device associated with the employee. In some embodiments, the method may generate a request to send to the mobile device, wherein the request may confirm the employee has begun work.

According to another embodiment, an apparatus for tracking employees is also described. The apparatus may include a processor, a memory in electronic communication with the processor and instructions stored on the memory of the processor. The processor may execute the instructions to register a mobile device associated with an employee, recognize when the mobile device associated with the employee enters a location, monitor the mobile device once it enters the location and generate a report based at least in part on the monitoring.

According to another embodiment, a computer-program product for tracking employees is also disclosed. The computer-program product may include a non-transitory computer-readable medium that may store instructions executable by a processor. The instructions may register a mobile device associated with an employee, recognize when the mobile device associated with the employee enters a location, monitor the mobile device once it enters the location and generate a report based at least in part on the monitoring.

The foregoing has outlined rather broadly the features and technical advantages of examples according to the disclosure such that the following detailed description may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of an example of another environment in which the present systems and methods may be implemented;

FIG. 3 is a block diagram of an example employee tracking module of the environment shown in FIGS. 1 & 2;

FIG. 4 is a block diagram of an example mobile device tracking module of the environment shown in FIG. 3;

FIG. 5 flow diagram illustrating a method of tracking an employee;

FIG. 6 is a flow diagram illustrating another method of tracking an employee;

FIG. 7 a block diagram of a computer system suitable for implementing the present systems and methods of FIGS. 1-6;

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to tracking employees. More specifically, the systems and methods described herein relate to an automated system for tracking the comings, goings, and activities of employees. In one example, a mobile device associated with the employee may allow tracking and recording of information relating to the employee's job duties. In some cases, this information may be analyzed and compiled in a report.

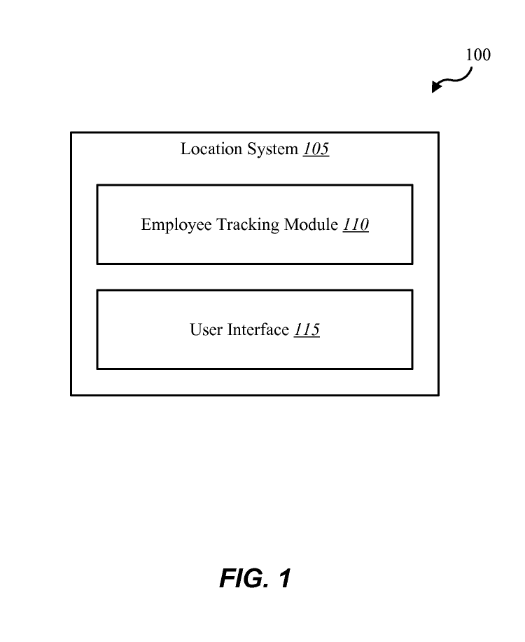

FIG. 1 is a block diagram illustrating one environment 100 on which the methods and disclosure may be implemented. The environment 100 may include a location system 105. The location system 105 may include an employee tracking module 110 and a user interface 115. While FIG. 1 shows the employee tracking module 110 and the user interface 115 included within the location system 105, these and other components of the environment 100 may be housed separately and operate independently while still working cooperatively with each other and other components of the location system 105.

The employee tracking module 110 may be configured track an employee or multiple employees throughout their shifts and perform any plurality of functions in response to employee tracking data. For purposes of clarity, employee will be used throughout the specification but may refer to multiple employees. In some embodiments, the employee tracking module 110 may be a mostly passive tracking system requiring little to no user input. In other embodiments, the employee tracking module 110 may be a combination active/passive system or a mostly active system. The user interface 115 may interact with the employee tracking module 110 and receive active tracking information such as clock-in information, clock-out information, and the like. In some embodiments, the user interface 115 may be associated with an employee tracking system onsite at a commercial location. In other embodiments, the user interface 115 may be integrated with the employee's device.

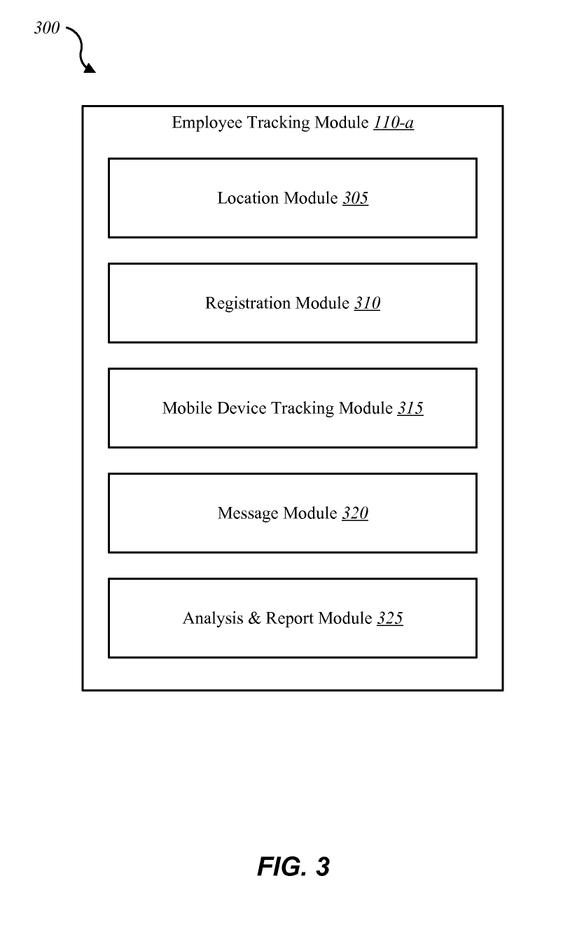

The employee tracking module 110 may, in addition to receiving employee work and device data, have the capability to store the data, analyze the data, create notifications related to the data, store criteria against which the data is evaluated, and other functions as described in further detail below with reference to FIG. 3. The employee tracking module 110 may include the capability to confirm identification of an employee using any of a variety of identification verification techniques. Employee tracking module 110 may also be capable of receiving communications from a remote device in response to or separate from the employee work and device data. The employee tracking module 110 may perform additional functions in response to instructions received from a remote source.

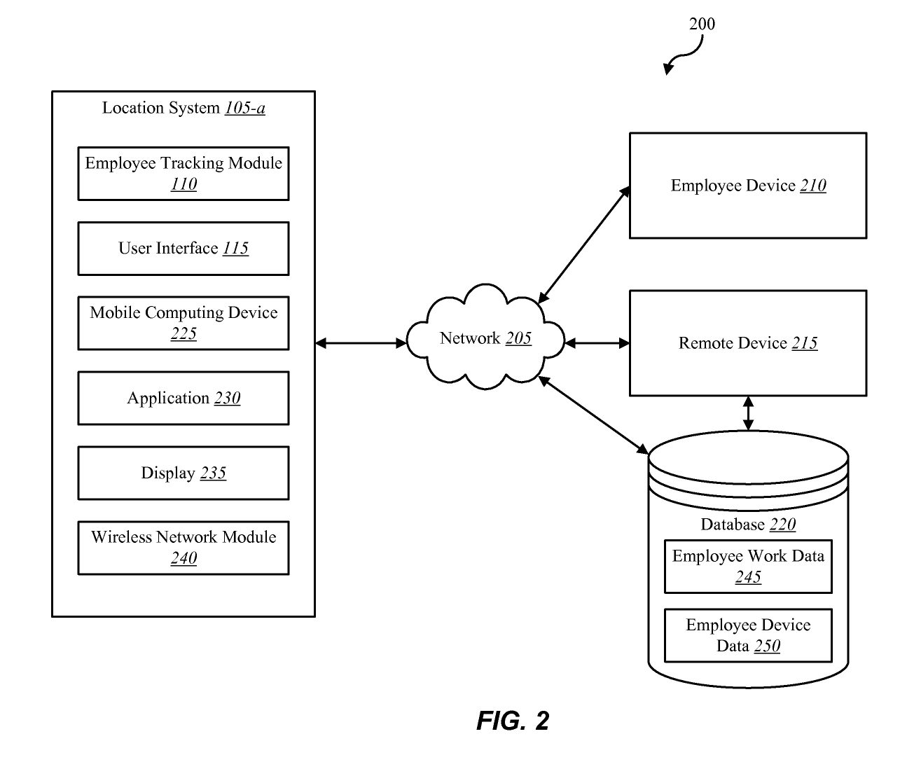

Referring now to FIG. 2, in some embodiments, an environment 200 may include the components of environment 100 described above, and may further include a network 205, an employee device 210, a remote device 215, and a database 220. The location system 105-a may be one example of the location system 105 described above with reference to FIG. 1. The location system 105-a may include, in addition to the employee tracking module 110 and the user interface 115, a mobile computing device 225, an application 230, a display 235, and a wireless network module 240. A database 220 may include (e.g., store) employee work data 245 and/or employee device data 250.

The location system 105-a may include various components and functionalities that work cooperatively with the employee tracking module 110 and the user interface 115, and/or may operate independently of the employee tracking module 110 and the user interface 115. For example, the wireless network module 240 may provide a wireless network for the location system 105-a. In some embodiments, the application 230 may use the wireless network provided by the wireless network module 240 to perform tasks related to the employee tracking module 110.

In some embodiments, the mobile computing device 225 may include one or more processors, one or more memory devices, and/or a storage device. Examples of the mobile computing device 225 may include mobile computing devices, smartphones, personal computing devices, computers, servers, etc. The mobile computing device 225 may be operable independent of features of the employee tracking module 110 and the user interface 115. Alternatively, at least some functionality of the mobile computing device 225 may cooperate with and/or interface with the employee tracking module 110 and/or the user interface 115.

The application 230 may allow a user to control (either directly or indirectly) an aspect of the property where the location system 105-a is located, including configuring the wireless network module 240 to create a virtual perimeter around the property. In some configurations, the application 230 may also interface between, for example, the employee tracking module 110, the user interface 115, the mobile computing device 225, or the display 235. Thus, the application 230, via the user interface 115, the display 235, and/or the mobile computing device 225, may allow users to monitor employees while the employees are present at the location. Information or data associated with the application 230 and its operation may be saved according to the data storage methods described herein.

In some embodiments, a user may access the functions of the location system 105-a from the mobile computing device 225. For example, in some embodiments, the mobile computing device 225 includes a mobile application that interfaces with one or more functions of the location system 105-a (e.g., employee tracking module 110). Examples of the mobile computing device 225 may include a personal computing device (e.g., a laptop, desktop, etc.), a mobile computing device (e.g., tablet computing device, smartphone, etc.), and the like. The employee tracking module 110 and/or the user interface 115 may be integrated with the mobile computing device 225 in the form of one or more personal computing devices (e.g., mobile devices, smartphones, and/or personal computing devices) to control aspects of the location and/or monitor activities of an employee (e.g., clock-in, clock-out, perform duties, job performance, etc.).

In some embodiments, the employee device 210 may be a mobile device unique to an employee. The employee device 210 may include, for example, a personal computing device (e.g., laptop), a mobile computing device (e.g., tablet computing device, smartphone, etc.), a wearable device, a multi-purpose portable device, a multi-purpose pocket computer, or the like. The employee device 210 may be in communication with the employee tracking module 110 or other features or components of the location system 105-a via, for example, the network 205. In other embodiments, the employee device 210 may connect to the location system 105-a using a wireless network provided by the wireless network module 240. The employee device 210 may be capable of two-way communication with the employee tracking module 110 and other features of the location system 105-a including, for example, receiving notifications from and sending information (e.g., notifications, time entry information, etc.) back to the employee tracking module 110 or other features of the location system 105-a. The employee device 210 may include a display and/or user interface. Notifications may be received on the employee device 210 in the form of, for example, a text message, email, audible signal, picture, ping message, etc. The notifications received at the employee device 210 may be in response to employee work data and/or employee device data which is collected and/or generated via the employee tracking module 110 and/or the user interface 115 and delivered to the remote device 215 and/or the database 220, or directly to the employee device 210. The employee device 210 may also include storage capability to store data such as employee work data, employee movement, notifications, schedules, contact information, and the like associated with their employment.

The remote device 215 may also communicate with the employee tracking module 110 and other features and components of the location system 105-a via, for example, the network 205. The remote device 215 may be any of a number of electronic devices including, for example, a dedicated automation computing device (e.g., wall-mounted controller), a personal computing device (e.g., laptop, desktop, etc.), a mobile computing device (e.g., a tablet computing device, smartphone, etc.), and the like. The remote device 215 may be located physically away from the location system 105-a or components thereof such as, for example, the user interface 115. The remote device 215 may be accessed by, for example, an owner of the place of business, manager, supervisor, or other personnel associated with the place of business where the employee is employed. The remote device 215 may be configured for two-way communication with the employee tracking module 110 and other features of the location system 105-a. The remote device 215 may receive notifications and information associated with an employee (e.g., employee work data or employee device data). The employee work data 245 and/or employee device data 250 may be accessed directly from the database 220, from the employee device 210 via, for example, the network 205 and/or the employee tracking module 110, or other components of the location system 105-a. The employee work data 245 and/or the employee device data 250 may be in the form of raw data such as, for example, times at which an employee clocks-in or clocks-out, days of the week that an employee logs at least some hours of work, employee safety data entered by employee, or employee movement and productivity while onsite, and other data associated with the employment. The employee work data 245 and/or the employee device data 250 may also include at least partially analyzed and/or processed data such as a comparison of an employee's hours to other similarly situated employee's, whether an employee's hours meet a certain criteria, whether the employee arrived on time, whether the employee clock-in time corresponds to an employee device clock-in time, whether the employee took too many breaks, or was stagnant for an extended period of time, logged into work late, etc.

The remote device 215 may include a user interface, storage capability, and other features and functionalities that permit the remote device 215 to not only receive notifications and data, but to also send instructions, data, notifications, and the like. The remote device 215 may receive employee work and device data, analyze the data, store the analyzed data (e.g., in database 220), and send notifications to the employee device 210, the employee tracking module 110, or other components of the location system 105-a, or to another location or remote device 215.

The network 205 provides communication via, for example, wired or wireless connections. Further, the network 205 may include a plurality of communication mediums. For example, the network 205 may include different communication mediums to provide communication between the employee tracking module 110 and/or other components of the location system 105-a and other devices such as the employee device 210, the remote device 215, and the database 220. Examples of the network 205 may include cloud networks, local area networks (LAN), wide area networks (WAN), virtual private networks (VPN), wireless networks (using 802.11, for example) and/or cellular networks (using 3G and/or LTE, for example), etc. In some embodiments, the network 205 may include the internet.

FIG. 3 is a block diagram 300 illustrating one example of the employee tracking module 110-a. The employee tracking module 110-a may be one example of the employee tracking module 110 depicted in FIGS. 1 and/or 2. As depicted, the employee tracking module 110-a may include a location module 305, a registration module 310, a mobile device tracking module 315, a message module 320, and an analysis & report module 325. Other embodiments may include additional or, in some embodiments, less modules that that which is shown in FIG. 3.

The location module 305 may define a specific location. For example, the location module 305 may outline and create a virtual perimeter surrounding a location. The location module 305, in some instances, may work conjunctively with or independent of a wireless network module and/or an application (e.g. wireless network module 240 and application 230). Using wireless technology, the location module 305 may create a boundary that defines a perimeter of a location. For example, the location module 305 may set up a virtual perimeter around a fast food restaurant, a store-front, a general retail consumer such as Walmart, a home improvement store, a store-front in a mall, etc. The virtual perimeter may define the actual parameters of a building, a section inside a building, or encompass the grounds surrounding a building as well as the building. The virtual perimeter may be a type of geofencing. It may be set up using a wireless network, such as Wi-Fi, or in some embodiments, it may use a network such as the network 205 in FIG. 2.

In some embodiments, the location module 305 may establish a virtual perimeter and establish one or more sectors that define one or more zones within the virtual perimeter. For example, a store may have several different zones. The zones may correspond to specific locations within the store. For example, a home improvement store may have zones defining different sections of the store such as plumbing, gardening, electrical, lumber, etc. In another example, a fast food restaurant may have different zones such as office, kitchen, cashier, food storage area, dining room, grounds, etc. In other examples, most businesses may have zones defining the restrooms, break rooms, etc. The location module 305 may set up different sectors or mini-virtual perimeters within the larger virtual perimeter to geographically define the zones of the location.

In some embodiments, the registration module 310 may identify and link the employees to the employee tracking module 110-a. For example, the registration module 310 may receive input that a new employee needs to be added to the system. The input may come from an employer, a supervisor, etc. The input may contain a request. The request may contain information such as a name of the employee, an employee number, contact information associated with an employee, a mobile device identifier, or the like. The employee number may be a unique identifier that represents the employee in the employer's system. The contact information may be an email address, mobile phone address, social media contact, etc.

The mobile device identifier may be a variety of identifiers that uniquely identify a mobile device. For example, the mobile device identifier may be a serial number of a device, a Bluetooth address, a Wi-Fi address, an international mobile station equipment identity (IMEI) number, an integrated circuit card identifier (ICCID), a mobile equipment identifier (MEID), or any other unique mobile device identifier. In some embodiments, the employer may submit the unique device identifier when adding the employee to the system. In other embodiments, the registration module 310 may pull the information from the mobile device. For example, if the employee is emailed a link, the link may be accessed on the mobile device and provide information back to the registration module 310. The registration module 310 may then create a unique employee profile containing a unique mobile device identifier.

In some embodiments, the registration module 310 may require the employee to download an application onto their mobile device. For example, the employee may access an application “store” from their device. From the application store, the employee may download an application associated with the employer, or associated with a service provider used by the employer. The mobile application may be installed directly on the device and may allow the registration module 310 to uniquely identify the device. In some embodiments, the application may be a passive application and run in the background on the user's mobile device. In other embodiments, the application may be an active application and require, allow, and/or enable interactions with the employee.

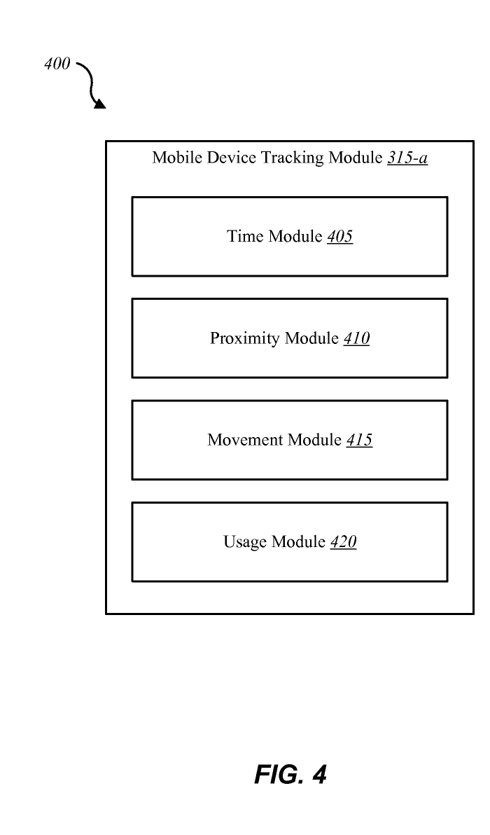

FIG. 4 is a block diagram 400 illustrating one example of a mobile device tracking module 315-a. The mobile device tracking module 315-a may be one example of the mobile device tracking module 315 displayed in FIG. 3. As depicted, the mobile device tracking module 315-a may include a time module 405, a proximity module 410, a movement module 415 and a usage module 420. Other embodiments may include additional or fewer capabilities than those illustrated in FIG. 4.

The time module 405 may be configured to record time data relating to the employee's work functions. For example, the time module 405 may determine when the employee's mobile device has crossed into the virtual perimeter that defines the business location. In some embodiments, the mobile device may connect to a wireless network associated with the business location. The time module 405 may determine when the mobile device connects based on the unique identifier associated with the mobile device. In some embodiments, multiple employees may connect to the wireless network. In such cases, the time module 405 may differentiate between employees using the unique identifier associated with each mobile device.

In some embodiments, when the mobile device connects to the wireless network, the time module 405 may record a clock-in time for the employee. This may be a passive action occurring without the employee's knowledge. In other embodiments, the time module 405 may prompt the employee to confirm a clock-in time. For example, when an employee first arrives at a location, the employee may need to stow their lunch, put away their personal belongings and/or the like prior to starting work. In those embodiments, the employee may be prompted via their mobile device to clock-in to work upon arrival. The employee may elect to dismiss the prompt and/or be reminded again within a short time frame. This may allow the employee time to properly stow personal items and prepare for work. In other embodiments, the employee may additionally be required to clock-in to their employer using traditional methods.

In some embodiments, the employee may use their mobile device to clock-out or record break times. For example, the employee may record a break time by entering a break start time and a break end time. This may be performed for short breaks or longer breaks, such as meal breaks. The time module 405 may interface with the employee and track this information.

In some embodiments, the time module 405 may enable the employee to use their mobile device to clock-out of work. This may be an active or a passive action. For example, the time module 405 may detect when the employee's mobile device is no longer connected to the wireless network. Once the time module 405 detects this, it may clock-out the employee. In some embodiments, the time module 405 may compare this clock-out time with a scheduled clock-out time for the employee. The time module 405 may determine the times coincide and automatically log the employee out for the day. In other embodiments, the time module 405 may determine the scheduled clock-out time and the mobile device clock-out time do not coincide. The time module 405 may attempt to reconnect to the device to determine if it has left the wireless network. In some instances, the time module 405 may notify the employee that the mobile device is no longer connected and unless the employee takes further action, they will be officially clocked out for the day.

In some embodiments, the mobile device may appear to have left the wireless network because the battery has died. In those embodiments, the time module 405 may determine a remaining battery life on the device and alert the employee that the battery is getting low and the device requires charging. If the employee is unable to charge their mobile device, the time module 405 may not clock the employee out if their device loses battery but may require the employee to clock-out using alternative means.

The proximity module 410 may determine a location of the mobile device while the mobile device is within the virtual perimeter. For example, the proximity module 410 may determine a general location within the virtual perimeter such as the north-east corner, etc. In other embodiments, the proximity module 410 may determine which zone the mobile device is in. For example, one or more different sectors or mini-virtual perimeters may be established within the larger virtual perimeter. The proximity module 410 may determine which of the sectors the mobile device is in. The sectors may include a break room, outside of a building, or a specific section of the location. For example, the proximity module 410 may determine the mobile device is within a plumbing sector of a home improvement store.

In some embodiments, the proximity module 410 may alert the employee concerning their whereabouts in the location. For example, the employee may be in the break room for an extended period of time but may be not be schedule for a break or may have exceeded their allotted break time. The proximity module 410 may request the employee to return to work, that their break is complete, or that they are not scheduled for a break. In other embodiments, the proximity module 410 may alert the employee to return to a specific section of the store. For example, the employee may be scheduled to work in a lumber section of a home improvement store. The proximity module 410 may determine the employee is in the plumbing section and alert the employee to return to their proper section of the store.

In another embodiment, a customer may use the proximity module 410 to request an help in a certain section of a store. For example, a customer may need to use the dressing rooms at a clothing store. A device may be located near the dressing rooms and may allow the customer to request assistance. The device may connect to the proximity module 410. The proximity module 410 may determine a closest employee to the dressing rooms and request the employee to aid the customer at the dressing room section. In some embodiments, the employee may use their mobile device and relate to the proximity module 410 that they are assisting another customer. In that instance, the proximity module 410 may find the next closest employee for assistance and so on.

The movement module 415 may track and detect movement of the employee via their mobile device. For example, the movement module 415 may track and determine if the employee is currently in motion or is stagnant in a location. For example, in some instances, movement module 415 may track excessive movement of an employee. Excessive movement may consist of too many smoke breaks, bathroom breaks, or other such departures from their employment duties. In some embodiments, the movement module 415 may alert the employee to stop taking such breaks or departures form their normal duties. In other embodiments, the duties of the employee may require movement. For example, a store clerk may be required to walk around the store assisting customers. In those embodiments, the employee may be alerted if stagnant for an extended period of time. Conversely, if an employee's duties require them to remain in a certain section of the store, the movement module 415 may track excessive departures from the assigned section of the store.

The usage module 420 may track and record the amount an employee accesses and/or uses their mobile devices throughout the day. For example, if the employee downloaded an application onto their device, the usage module 420 may use the application to record the number of times the employee accesses their phone and for what purpose. The usage module 420 may determine the employee is excessively sending text messages, reviewing social media websites, checking email, or using other functionalities of their mobile device unrelated to their professional duties. In some embodiments, the usage module 420 may essentially lock the employees device, or prevent the employee from accessing any other functionalities on their mobile device except for the application that interfaces with their employer. In some embodiments, the application may unlock the device during the employees break times.

In some embodiments, the usage module 420 may record the wireless network traffic of the employee's mobile device. For example, the usage module 420 may interface with a wireless network module and/or an application (e.g. wireless network module 240, application 230) to record and determine the amount of activity occurring on the mobile device. In some embodiments, the usage module 420 may restrict the employee's access to the wireless network. For example, the usage module 420 may allow the employee to access the wireless network to enable employee tracking but may prevent the employee from sending any further information over the wireless network.

Returning back to FIG. 3, the message module 320 may facilitate the messages between the mobile device tracking module 315 and the employee. For example, the message module 320 may send a message to the employee when one of the thresholds are met in the mobile device tracking module 315. In some embodiments, the message may be sent as one of an SMS message, email, ping message, phone call or the like. In some embodiments, the message module 320 may facilitate communication with the employee using an application the employee downloaded to their mobile device.

In other embodiments, the message module 320 may additionally sent alerts and/or messages to the employee's supervisor. For example, when certain thresholds in the mobile device tracking module 315 are met, the supervisor may receive a message. Thresholds may be a late check-in time, excessive breaks, departures from assigned sectors, etc. In other embodiments, the supervisor may receive alerts notifying the supervisor of the employee's above average performance. In further embodiments, the supervisor may receive notices when the employee has worked extended overtime, is nearing an overtime rate or other such notifications. Additionally or alternatively, the supervisor may select employees and receive more specific updates regarding the employee's activities. For example, a supervisor may wish to track an employee with a poor track record, poor performance, poor reviews, or a similar situation. The supervisor may elect to receive specific notifications about the employee to determine if the employee is improving, etc. In still further embodiments, the supervisor may receive randomly generated messages concerning employees. The randomly generated messages may be completely random and chosen from a pool of employees and different types of alerts.

In some embodiments, the analysis & report module 325 may analyze the data gathered by the employee tracking module 110-a and/or the mobile device tracking module 315 and generate various reports. In some embodiments, the analysis & report module 325 may analyze the time entry data and generate time reports. The time reports may contain time in, time out and break time reports tracked by the mobile device tracking module 315. In some embodiments, the analysis & report module 325 may compare the mobile device data to other work entry data, for example, time entry data using an alternative system. In some instances, the mobile device data may confirm the manually entered time entry data and prevent a supervisor from having to verify time entry reports.

In other embodiments, the analysis & report module 325 may provide data relating to the employee's whereabouts during the work day. The report may be routinely generated, may be generated only when certain thresholds are met, or may be generated for employees on probation. The report may provide a map of the location and locations of the employee throughout their day. In other instances, the report may be a log of the employee's movement and motion throughout the day. In other embodiments, the report may analyze and refine the data to highlight the various deviations the employee took throughout the day. For example, the report may highlight the times the employee left their assigned sector, the number of trips to the break room, bathroom, or outside and other deviations from the normal course of business.

The frequency and type of reports may be specified by the employer and/or supervisor. The analysis & report module 325 may generate an endless series of reports based on collected data. The analysis & report module 325 may also generate reports on any specific frequency. The reports may be daily, weekly, monthly, they may coincide with the pay period, or the like. The reports may also be generated on a longer term basis, such as annual or bi-annual reports. In some instances, annual or bi-annual reports may aid a supervisor in a review process and may help determine whether to promote, retain, or, in some instances, release employees.

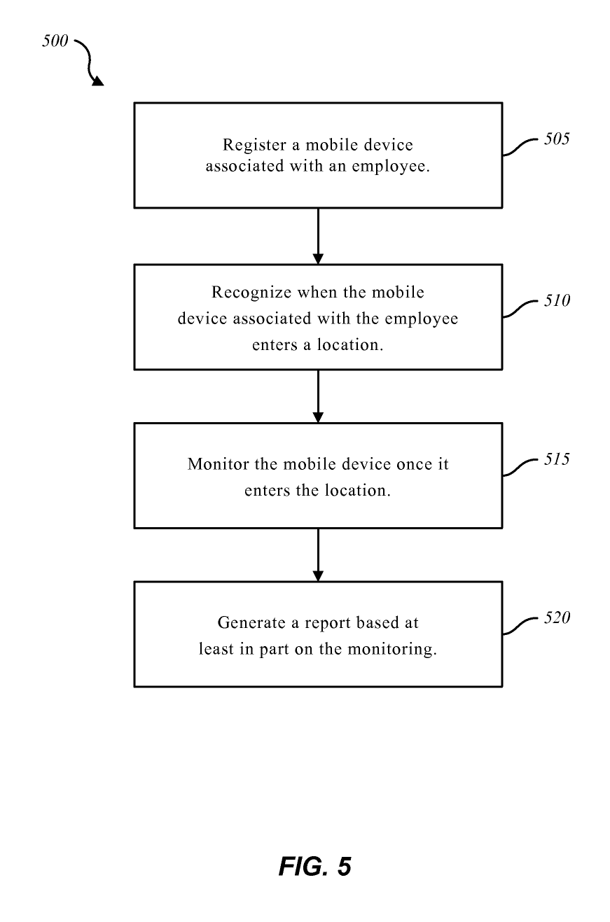

FIG. 5 is a flow diagram illustrating one embodiment of a method to employee tracking. In some configurations, the method 500 may be implemented by the employee tracking module 110 of the location system 105 shown in FIGS. 1 and/or 2. In other examples, the method 500 may be performed generally by the location system 105 shown in FIGS. 1 and/or 2, or even more generally by the environments 100, 200 shown in FIGS. 1 and/or 2.

At block 505, a mobile device associated with an employee may be registered. For example, an employer may wish to track a mobile device associated with an employee. The employer may add the employee to their location system. The employee may then, receive via their mobile device, a request to join the location system. The request may gather specific information such as a unique identifier to correctly and uniquely identify the device.

At block 510, it may be recognized when the mobile device associated with the employee enters a location. For example, the location system (e.g. location system 105) may use the unique identifier associated with the device to identify the mobile device when it crosses a virtual perimeter that may be associated with the location. At block 515, the mobile device may be monitored once it enters the location. For example, a location, proximity, movement, or the like may be monitored and, in some instances, recorded.

At block 520, a report may be generated based at least in part on the monitoring. The report may contain all of the monitoring data associated with the mobile device. In other embodiments, the report may generate an analysis of the data. For example, the report may only provide information such as deviations or other such breaks from normal employment duties. In other embodiments, the report may compare mobile device data to a schedule and determine the timeliness of an employee. This type of report may allow a supervisor to quickly peruse and verify a time entry log using a mobile device time entry database. The report may compare time-stamps from the mobile device with the time entry log and automatically validate the time entry log. In some embodiments, the supervisor may wish to see the comparison. In other embodiments, the report may only highlight any discrepancies between the time-stamps and the time entry log.

Other steps of method 500 may include requiring the employee to download an application to their mobile device, sending reminders of upcoming shifts to employees, reminding employees when their breaks begin and/or end, sending alerts to supervisors if the employee significantly deviates from their job duties, reminding the employee to charge their mobile device if the battery is low, recording employee time entry data, and analyzing the data collected to generate a variety of reports.

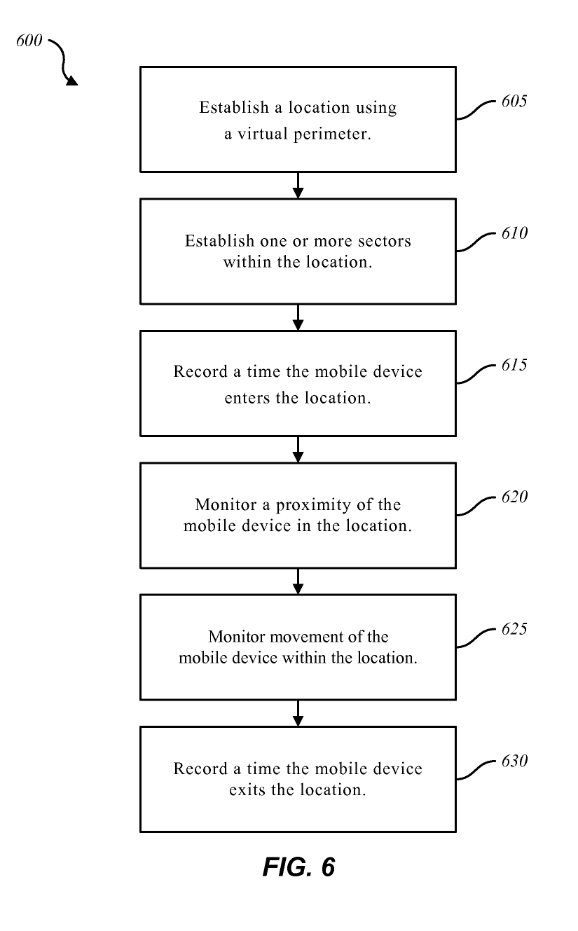

FIG. 6 is a flow diagram illustrating an embodiment of another method 600 for employee tracking. In some configurations, the method 600 may be implemented by the employee tracking module 110 of the location system 105 shown in FIGS. 1 and/or 2. In other examples, the method 600 may be performed generally by the location system 105 shown in FIGS. 1 and/or 2. Even still more generally, the method 600 may be performed generally by the environments 100, 200 shown in FIGS. 1 and/or 2.

At block 605, a virtual perimeter may establish a location. For example, the location may have a wireless network associated with it. The wireless network may be established by a wireless network module or an employee tracking module (e.g. wireless network module 240, employee tracking module 110). In other embodiments, a virtual perimeter may be established using a network and geofencing technologies (e.g. network 205). The virtual perimeter may establish a building, a store within a building, or a building and grounds, or just the grounds. The virtual perimeter may be largely undetected by people passing through but may be detectable by either a location system or an employee device (e.g. location system 105 or employee device 210).

At block 610, one or more sectors within the location may be established. The one or more sectors may be established using a wireless network or a network. The one or more sectors may define one or more zones within the location. For example, the zones may establish inside and outside of a building. It may define different zones of a restaurant (e.g. kitchen, dining room, bathrooms, cashiers, bar, etc.), different zones of a grocery store (e.g. produce, meat, baked goods, frozen section, etc.), and/or the like.

At block 615, the time the mobile device enters the location may be recorded. For example, the mobile device may enter the virtual perimeter defining the location. The location may be a commercial location and the mobile device may be associated with an employee of the commercial location. When the employee enters the location, the mobile device, which may be on the employee's person, may also enter the location. Since the location may be defined by a virtual perimeter, a location system and/or the mobile device may determine when the virtual perimeter is crossed. In some embodiments, the method may generate and send a message to the employee to remind them to clock-in to work. The employee may clock-in using traditional time keeping methods and/or may additionally clock-in using their mobile device. In further embodiments, after the employee has entered the virtual perimeter, the method may generate a request to send to the mobile device. The request may confirm the employee has begun work and may subsequently clock-in the employee.

At block 620, a proximity of the mobile device may be monitored within the location. For example, a manager or supervisor of the employee may receive an alert when the employee lingers in one proximity for an extended period of time. In another embodiment, the method may track the proximity of the mobile device as it conjunction with a map such that a location of the employee may be present at any given time to an employer, supervisor, manager or the like. For example, a manager may not be working at the same time as the employee. In some embodiments, the manager may access a site to enable the manager to view a location of all the employees currently working. In some embodiments, the manager may view all of the employees working or it may select which specific individuals or groups of individuals to view on a map. For example, a manager may track all individuals that are cashiers on a map and determine who is on break, or if a cashier is taking an unapproved or unexpected break.

At block 625, the movement of the mobile device may be monitored within the location. For example, the method may monitor the movement of the mobile device between the different sectors of the location. A log may be generated as to when and how long the employee was within each sector and how often the employee moved between sectors. Additionally or alternatively, the employee may receive alerts if the employee is moving too much or too little. For example, some employment duties require the movement of employees through a location. In such an environment, the mobile device may receive a message alerting the employee that they have been stagnant for too long. Being stagnant may include either not moving or not moving between sectors quickly or effectively enough. In other embodiments, employment duties may require an employee to remain in a specific location. For example, a hotel concierge may be required to remain at the concierge desk for their entire shift. The mobile device associated with the hotel concierge may receive a notice that the concierge has left the desk too frequently and needs to return to their duties. In some embodiments, these types of alerts may also be sent to a supervisor, manager, employer or the like. The employee may also have a log associated with their employment that tracks this information.

At block 630, a time the mobile device exits the location may be recorded. For example, the employee may leave for a lunch break and the time the mobile device exits the location may be recorded at a lunch break time. In another embodiment, the employee may have completed their shift and the time the mobile device exits the location may be recorded as a clock-out time. In some embodiments, the employee may receive a message on their mobile device asking them if they forgot to clock or alerting them that unless they return to the location within a specified time period, they will be clocked-out for the day. In some embodiments, the exit time may be compared to a schedule that includes the employee's hours. The method may compare the exit time to the employee's scheduled hours and determine the employee should be clocked-out and may automatically clock-out the employee without any notice to the employee.

In some embodiments, other steps of method 600 may include portions of the method 500. In other embodiments, the method of 600 may include establishing a wireless network, comparing enter and exit times with scheduled shift times, prompting the employee to clock-in and clock-out, reminding the employee of break start times and end times, sending notices to the employees if they deviate from their responsibilities, sending notifications to supervisors of employee work deviations, registering multiple devices associated with different employees and differentiating between the devices, calculating a total time spent within the location, generating and sending a message to remind the employee to log into work, confirming the employee has begun work and the like.

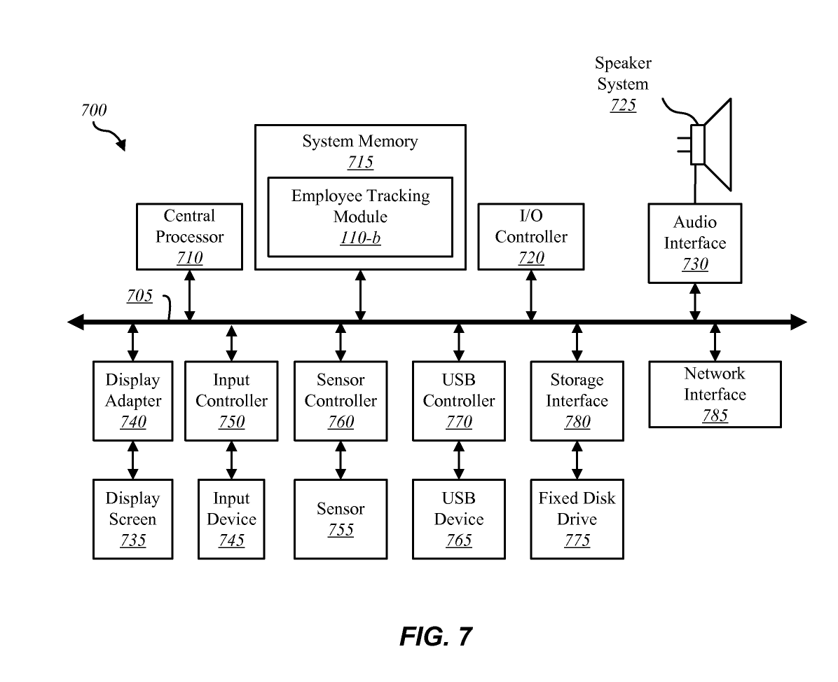

FIG. 7 depicts a block diagram of a computer system 700 suitable for implementing the present systems and methods. The computer system 700 may be an example of the mobile computing device 225, the remote device 215, the employee device 210, the database 220, and/or some combination thereof illustrated in FIG. 2. In one configuration, the computer system 700 may include a bus 705 which interconnects major subsystems of the computer system 700, such as a central processor 710, a system memory 715 (typically RAM, but which may also include ROM, flash RAM, or the like), an input/output controller 720, an external audio device, such as a speaker system 725 via an audio output interface 730, an external device, such as a display screen 735 via display adapter 740, an input device 745 (e.g., remote control device interfaced with an input controller 750), multiple USB devices 765 (interfaced with a USB controller 770), one or more cellular radios 790, and a storage interface 780. Also included are at least one sensor 755 connected to bus 705 through a sensor controller 760 and a network interface 785 (coupled directly to bus 705).

The bus 705 may allow data communication between the central processor 710 and the system memory 715, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, an employee tracking module 110-b to implement the present systems and methods may be stored within the system memory 715. Applications (e.g., application 230) resident with the computer system 700 are generally stored on and accessed via a non-transitory computer readable medium, such as a hard disk drive (e.g., fixed disk drive 775) or other storage medium. Additionally, applications can be in the form of electronic signals modulated in accordance with the application and data communication technology when accessed via the network interface 785.

The storage interface 780, as with the other storage interfaces of the computer system 700, can connect to a standard computer readable medium for storage and/or retrieval of information, such as a fixed disk drive 775. The fixed disk drive 775 may be a part of the computer system 700 or may be separate and accessed through other interface systems. The network interface 785 may provide a direct connection to a remote server via a direct network link to the Internet via a POP (point of presence). The network interface 785 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., documents scanners, digital cameras, and so on). Conversely, all of the devices shown in FIG. 7 need not be present to practice the present systems and methods. The devices and subsystems can be interconnected in different ways from that shown in FIG. 7. The aspect of some operations of a system such as that shown in FIG. 7 are readily known in the art and are not discussed in detail in this application. Code to implement the present disclosure can be stored in a non-transitory computer-readable medium such as one or more of system memory 715 or fixed disk drive 775. The operating system provided on the computer system 700 may be iOS® ANDROID®, MS-DOS®, MS-WINDOWS®, OS/2® UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method to track employees, comprising:
registering a mobile device associated with an employee,
recognizing when the mobile device associated with the employee enters a location;
prompting the employee to perform a registration process associated with the location after recognizing the mobile device has entered the location;
receiving a confirmation from the employee that the registration process has been performed;
monitoring the mobile device once it enters the location based at least in part on receiving the confirmation; and
generating a report based at least in part on the monitoring.

2. The computer implemented method of claim 1, wherein the location is defined by a virtual perimeter created by a wireless network.

3. The computer-implemented method of claim 2, wherein the virtual perimeter incorporates a business location.

4. The computer-implemented method of claim 1, wherein monitoring the mobile device further comprises:
monitoring movement of the mobile device within the location.

5. The computer-implemented method of claim 1, further comprising:
establishing the location, wherein establishing the location includes setting up a wireless network.

6. The computer-implemented method of claim 1, further comprising:
registering multiple mobile devices, each mobile device associated with a different employee; and
differentiating between the mobile devices when the mobile devices enter the location.

7. The computer-implemented method of claim 1, wherein the report contains time-stamps relating to when the employee entered and exited the location.

8. The computer-implemented method of claim 7, wherein the report compares the time-stamps to a time entry log from a time entry database.

9. The computer-implemented method of claim 1, further comprising:
generating a message to remind the employee to clock-in to work; and
sending the message to the mobile device associated with the employee.

10. The computer-implemented method of claim 1, further comprising:
generating a request to send to the mobile device, wherein the request confirms the employee has begun work; and
sending the request to confirm the employee has begun work.

11. The computer-implemented method of claim 1, wherein the location is a commercial location.

12. The computer implemented method of claim 1, further comprising:
establishing one or more sectors within the location, wherein the one or more sectors define one or more different zones of the location.

13. The computer-implemented method of claim 6, wherein monitoring the mobile device further comprises:
recording a time when the mobile device enters the location;
recording a time when the mobile device leaves the location; and
calculating a total time the mobile device was within the location.

14. An apparatus for tracking employees, comprising:
a processor;
a memory in electronic communication with the processor; and
instructions stored in the memory, the instructions being executable by the processor to:
register a mobile device associated with an employee,
recognize when the mobile device associated with the employee enters a location;
prompt the employee to perform a registration process associated with the location after recognizing the mobile device has entered the location;
receiving a confirmation from the employee that the registration process has been performed;
monitor the mobile device once it enters the location based at least in part on receiving the confirmation; and
generate a report based at least in part on the monitoring.

15. The apparatus of claim 14, wherein the instructions are executable by the processor to:
generate a message to remind the employee to clock-in to work; and
send the message to the mobile device associated with the employee.

16. The apparatus of claim 14, wherein the instructions are executable by the processor to:
generate a request to send to the mobile device, wherein the request confirms the employee has begun work.

17. A computer-program product for tracking employees, the computer-program product comprising a non-transitory computer-readable medium storing instructions executable by a processor to:
register a mobile device associated with an employee,
recognize when the mobile device associated with the employee enters a location;
prompt the employee to perform a registration process associated with the location after recognizing the mobile device has entered the location;
receiving a confirmation from the employee that the registration process has been performed;
monitor the mobile device once it enters the location based at least in part on receiving the confirmation; and
generate a report.

18. The computer-program product of claim 17, wherein the instructions are executable by the processor to:
monitor movement of the mobile device within the location.

19. The computer-program product of claim 17, wherein the instructions are executable by the processor to:
establish the location, wherein establishing the location includes setting up a wireless network; and
establish one or more sectors within the location, wherein the one or more sectors define different zones of the location.

20. The computer-program product of claim 17, wherein the instructions are executable by the processor to:
register multiple mobile devices, where each mobile device is associated with a different employee; and
differentiate between the mobile devices when the mobile devices enter the location.
